(19) United States
(12) Patent Application Publication
(10) Pub. No.: US 2016/0349282 A1
(43) Pub. Date: Dec. 1, 2016

(54) MOTION MEASURING DEVICE, MOTION MEASURING SYSTEM, MOTION MEASURING METHOD, AND MOTION MEASURING PROGRAM

(71) Applicant: SEIKO EPSON CORPORATION, Tokyo (JP)

(72) Inventors: Naoki GOBARA, Shiojiri-shi (JP); Akifumi HAYASHI, Matsumoto-shi (JP)

(73) Assignee: SEIKO EPSON CORPORATION, Tokyo (JP)

(21) Appl. No.: 15/167,942

(22) Filed: May 27, 2016

(30) Foreign Application Priority Data
May 29, 2015 (JP) 2015-109432

(51) Int. Cl. G01P 13/00

(52) U.S. Cl. CPC G01P 13/00

(57) ABSTRACT

A motion measuring device includes a processor which measures a motion with the use of a signal generated by a sensor . The processor switches an item for the measurement of motion to another item for measurement of motion according to a site of installation of the sensor.

### CROSS-REFERENCE TO RELATED APPLICATION

The entire disclosure of Japanese Patent Application No. 2015-109432, filed May 29, 2015 is hereby expressly incorporated by reference herein.

### BACKGROUND

### 1. Technical Field

This disclosure relates to a motion measuring device, a motion measuring system, a motion measuring method, and a motion measuring program.

### 2. Related Art

Sports instruments for measuring and recording human motions with a sensor are becoming popular. For example, U.S. Patent Application Publication No. 2005/0038626 discloses a system in which the sports performance of a person is measured by an acceleration sensor mounted on the person or a vehicle.

However, since the system is specialized for only a predetermined variety of sports, if the user uses the system for other types of sports, the user may not necessarily be able to obtain necessary information.

Meanwhile, if various different data are collected with the sensor, it is possible extract necessary information by so-called post-processing in which data are processed after the user has finished playing sports. However, systems which perform such post-processing encounter problems such as a need for a large-capacity memory, a significant increase in the amount of data to be transmitted to outside from the sensor (a need for high-speed communications), and an increase in the power consumption by the sensor.

### SUMMARY

An advantage of some aspects of this disclosure is to provide a motion measuring device, a motion measuring system, a motion measuring method and a motion measuring program that are more versatile than those currently known in the art.

This disclosure can be implemented as the following configurations or application examples.

### APPLICATION EXAMPLE 1

A motion measuring device according to this application example includes a processor which executes measuring a motion with the use of a signal generated by a sensor, and switching an item for the measurement to another item according to a site of installation of the sensor.

The processor can measure a motion, switching items for measurement according to the site of installation of the sensor. Therefore, the motion measuring device according to this application example is more versatile than in the case where items for measurement are fixed regardless of the site of installation.

### APPLICATION EXAMPLE 2

In the motion measuring device according to the second application example, the processor may be able to use a signal generated by a plurality of the sensors, and may eliminate a sensor of the plurality of sensors that is not being used for the measurement of the item from being supplied with power.

Thus, since the processor can perform measurement using the plurality of sensors, the versatility of the motion measuring device can be improved, compared with the case where there is only one sensor. Also, the processor eliminates a sensor that is not used for measurement from being supplied with power. Therefore, the amount of power consumed by the plurality of sensors can be restrained, compared with the case where all of the plurality of sensors is made to operate regardless of the particular item being measured.

### APPLICATION EXAMPLE 3

In the motion measuring device according to the third application example, the processor may switch the item being measured to another item according to a use of the sensor.

The processor can switch items for measurement according to the use in addition the site of installation. Therefore, the motion measuring device according to this application example is more flexible in measurement than in the case where items are switched according to one of the site of installation and the use.

### APPLICATION EXAMPLE 4

In the motion measuring device according to the fourth application example, the processor may further limit the item being measured in response to a request by a user.

Thus, the motion measuring device according to this application example can improve efficiency of measurement by limiting items being measured in response to a request by the user.

### APPLICATION EXAMPLE 5

The motion measuring device according to the sixth application example may further include an input device which accepts an input of information about the site of installation.

Thus, the user can input information about the site of installation to the motion measuring device.

### APPLICATION EXAMPLE 6

The motion measuring device according to the sixth application example may further include an input device which accepts an input of information about the use.

Thus, the user can input information about the use to the motion measuring device.

### APPLICATION EXAMPLE 7

The motion measuring device according to the seventh application example may further include an input device which accepts an input of the request.

Thus, the user can input his/her own request to the motion measuring device.

### APPLICATION EXAMPLE 8

The motion measuring device according to the eighth application example may further include a notification device which notifies a user of a result of the measurement.

Thus, the user can confirm the result of measurement on the basis of a notification from the motion measuring device.

### APPLICATION EXAMPLE 9

The motion measuring device according to the ninth application example may further include the sensor.

In this case, both the functions of the motion measuring device according to one of the above application examples and the function of at least one of the sensors can be achieved by a single device.

### APPLICATION EXAMPLE 10

The motion measuring device according to the tenth application example may further include a communication device which receives the signal from at least one of the sensors.

Since the motion measuring device can receive the signal from the sensor via the communication device, various configurations are possible, such as a configuration in which the sensor and the motion measuring device are separated, for example.

### APPLICATION EXAMPLE 11

A motion measuring system according to the eleventh application example includes a motion measuring device including a processor which measures a motion with the use of a signal generated by a sensor, and switches an item for the measurement to another item according to a site of installation of the sensor, and a sensor device including the sensor.

The processor of the motion measuring device can measure a motion, switching items for measurement according to the site of installation of the sensor. Therefore, the motion measuring system according to this application example is more versatile than in the case where items for measurement are fixed regardless of the site of installation.

### APPLICATION EXAMPLE 12

A motion measuring method according to the twelfth application example includes measuring a motion with the use of a signal generated by a sensor and switching an item for the measurement to another item according to a site of installation of the sensor.

In the motion measuring method according to this application example, a motion can be measured with items for measurement switched according to the site of installation of the sensor. Therefore, the motion measuring method according to this application example is more versatile than in the case where items for measurement are fixed regardless of the site of installation.

### APPLICATION EXAMPLE 13

A motion measuring program according to the thirteenth application example causes a computer to measuring a motion with the use of a signal generated by a sensor and switching an item for the measurement to another item according to a site of installation of the sensor.

With the motion measuring program according this application example, a motion can be measured with items for measurement switched according to the site of installation of the sensor. Therefore, the motion measuring program according to this application example is more versatile than in the case where items for measurement are fixed regardless of the site of installation.

### BRIEF DESCRIPTION OF THE DRAWINGS

This disclosure will be described with reference to the accompanying drawings, wherein like numbers reference like elements.

FIG. 1 explains an outline of a motion measuring system according to an embodiment of the invention;

FIG. 2 explains the configuration of a motion measuring system 1 according to an embodiment of the invention;

FIG. 3 explains an example of a setting table 291 stored in a master module 20;

FIG. 4 is a time chart explaining operations of the master module 20 and a sensor module 10;

FIGS. 5A-5F illustrate an example of a series of select screens which may be displayed at the time of user setting; and

FIG. 6 explains an example of a display form of measured data.

### DESCRIPTION OF EXEMPLARY EMBODIMENTS

Hereinafter, preferred embodiments of this disclosure will be described in detail with reference to the drawings. It should be noted that the embodiments described below should not unduly limit the contents of this disclosure described in the appended claims. Also, not all the configurations described below are necessarily essential components of this disclosure.

### 1. Motion Measuring System

### 1-1. First Embodiment

### Outline of System

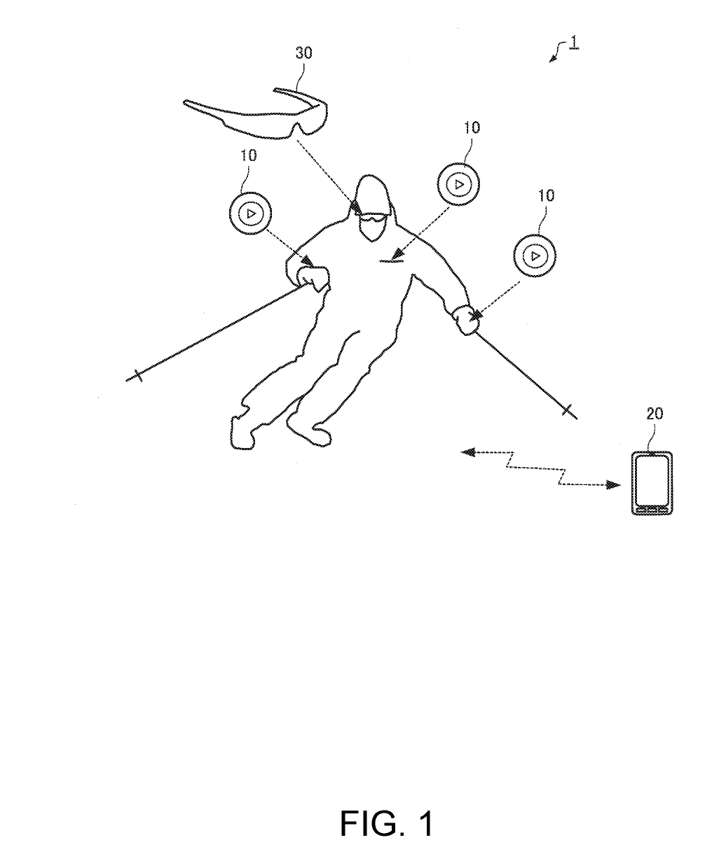

FIG. 1 explains an outline of the motion measuring system according to this embodiment. As shown in FIG. 1, a motion measuring system 1 includes a plurality of sensor modules (an example of a sensor device) 10, a master module (an example of a motion measuring device) 20, and a transmission-type head-mounted display 30.

Each of the plurality of sensor modules 10 is a general-purpose sensor module whose use is not particularly limited. The size of the sensor module 10 is, for example, the head size of a wristwatch or smaller. The weight of the sensor module 10 is, for example, the head weight of a wristwatch or less. The shape of the sensor module 10 is, for example, similar to the head of a wristwatch (for example, disc-shaped). Thus, the sensor module 10 can be easily mounted (installed) at an arbitrary site on a person who is exercising, sporting equipment, or the like.

The master module 20 is a terminal which is made up of a smartphone, for example, and can wirelessly communicate with each of the plurality of sensor modules 10. The master module 20 can also perform wireless or wired communication with the head-mounted display 30.

The user can arbitrarily choose the number of sensor modules 10 of the plurality of sensor modules 10 is used simultaneously, and the site of installation of each of the plurality of sensor modules 10, or the like. The user can also arbitrarily choose to use or not to use the head-mounted display 30.

The head-mounted display 30 is a display which can be mounted on the user's head. The head-mounted display 30 is equipped with, for example, a display element which displays an image or the like, an optical system which guides light emitted from the display element to the user's eyes along with light from the outer field, and a mounting for mounting the display element and the optical system on the user's head. The head-mounted display 30 may be also equipped with an input (for example, a button) for accepting an input, such as an instruction from the user, or the like.

In FIG. 1, the number of sensor modules 10 used simultaneously is three, and the use of the sensor modules 10 is skiing. The site of installation of one of the three sensor modules 10 is a chest pocket of the user. The site of installation of another sensor module 10 is a pocket in the right glove. The site of installation of the other sensor module 10 is a pocket in the left glove. In this example, the head-mounted display 30 is used.

The user can carry out various settings of the three sensor modules 10 via the master module 20 before starting exercise, and can input an instruction to start measuring to the three sensor modules 10 via the master module 20 at the start of exercise. The user can also confirm measured data (an example of information generated as a result of measuring) gathered by the three sensor modules 10, in real time via the master module 20 or the head-mounted display 30 during exercise. At the end of exercise, the user can input an instruction to end the measuring to the three sensor modules 10 via the master module 20. The expression “can confirm . . . in real time” here means that the user can confirm measured data of exercise during the exercise.

The user can switch the site to display information about system operations and the site to display information about measured data, between a display (for example, a touch panel display) of the master module 20 and a display (transmission-type display) of the head-mounted display 30. The user can also use an input (for example, a touch panel) of the master module 20 or can use an input (for example, a button) of the head-mounted display 30, as a user interface of the system.

To simplify the description, a case where the master module 20 is used as the site to display information and where the input (for example, a touch panel) of the master module 20 is used as the user interface is considered below.

### Configuration of System

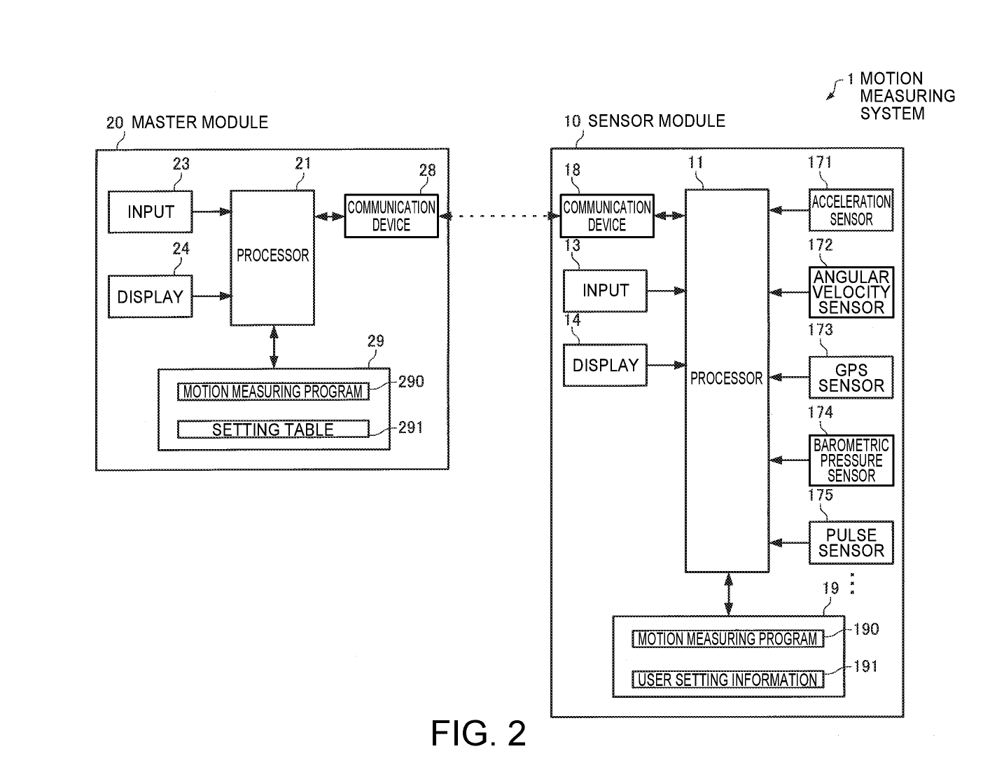

FIG. 2 explains the configuration of the motion measuring system 1 according to this embodiment. In FIG. 2, the master module 20 and one sensor module 10 are shown. The plurality of sensor modules 10 may have different program versions and different types of hardware (combinations of installed sensors) from one another. Here, however, to simplify the description, a case where all of the sensor modules 10 have the same configuration is described as an example. The description below focuses on the one sensor module 10 and the master module 20.

The master module 20 is provided with, for example, a processor 21, an input 23 (an example of an input device), a display 24 (an example of a notification device), a communication device 28, and a memory 29 or the like. In the memory 29, a motion measuring program 290 and a setting table 291 or the like are stored.

The processor 21 is made up of, for example, a CPU (central processing unit), DSP (digital signal processor), ASIC (application specific integrated circuit) or the like. The processor 21 operates according to various programs such as the motion measuring program 290 stored in the memory 29 and various commands inputted by the user via the input 23.

The input 23 is configured to convert the content of a command inputted by the user into an appropriate signal and provide the signal to the processor 21. The input 23 is implemented, for example, as a button, key, microphone, touch panel or the like.

The display 24 is configured to display image data, text data and the like sent from the processor 21, in the form of letters, graphs, tables, animations or other types of images. The display 24 is implemented as a display such as an LCD (liquid crystal display), organic EL (electroluminescence) display, or EPD (electrophoretic display), for example. The display 24 can also be made up of a touch panel display. In this case, at least apart of the functions of the input 23 maybe included in the display 24.

The communication device 28 includes a transmitter/receiver or the like conforming to a near field wireless communication standard such as Bluetooth (trademark registered) (including BTLE (Bluetooth Low Energy)), Wi-Fi (trademark registered) (Wireless Fidelity), Zigbee (trademark registered), NFC (near field communication), or ANT+ (trademark registered), for example. The communication device 28 receives electromagnetic waves in a predetermined frequency band arriving from an external source (for example, the sensor module 10, the head-mounted display 30, network server or the like, not shown) with a wireless antenna, not shown, then extracts a predetermined signal for near field wireless communication from the electromagnetic waves, restores information included in the signal, and outputs the information to the processor 21. The communication device 28 also superimposes information provided from the processor 21 onto the predetermined signal for near field wireless communication and transmits the signal to outside.

The memory 29 is made up of, for example, various IC memories such as ROM (read only memory), flash ROM or RAM (random access memory), or recording media such as hard disk and memory card. In the ROM, for example, programs such as the motion measuring program 290, the setting table 291, and other data are stored. In the RAM, for example, a memory area usable as a work area for the processor 21 is allocated.

The sensor module 10 is provided with, for example, a processor 11, an input 13, a display 14, a communication device 18, a memory 19, and one or a plurality of sensors or the like. The sensor installed in the sensor module 10 is, for example, an acceleration sensor 171, an angular velocity sensor 172, a GPS sensor 173 (global position system sensor), a barometric pressure sensor 174, a pulse sensor 175 and the like. Of these, the acceleration sensor 171 and the angular velocity sensor 172 are so-called inertial sensors. The GPS sensor 173 is a position sensor. The types of sensors and the number of sensors given here are only an example. For example, a plurality of sensors of the same type may be installed in one sensor module 10, and sensors other than the above may be installed as well. However, in the case of measuring human motions, it is desirable that at least one of an inertial sensor and a position sensor is installed in the sensor module 10.

The processor 11 is made up of, for example, a CPU (central processing unit), DSP (digital signal processor), ASIC (application specific integrated circuit) and the like. The processor 11 operates according to various programs such as a motion measuring program 190 stored in the memory 19 and various commands inputted by the user via the input 13.

The input 13 is configured to convert the content of a command inputted by the user into an appropriate signal and provide the signal to the processor 11. The input 13 is implemented, for example, as a button, key, microphone, touch panel or the like.

The display 14 is configured to display image data, text data and the like sent from the processor 11, in the form of letters, graphs, tables, animations or other types of images. The display 14 is implemented as a display such as an LCD (liquid crystal display), organic EL (electroluminescence) display, or EPD (electrophoretic display), for example. Since it is desired that the sensor module 10 has a small size, an audio interface, not shown, instead of the display 14, may be used as a mechanism to notify the user of information. The audio interface is configured to output audio data sent from the processor 11, in the form of a sound such as a voice or buzz. The audio interface is implemented, for example, as a speaker or buzzer.

The communication device 18 includes a transmitter/receiver or the like conforming to a near field wireless communication standard such as Bluetooth (trademark registered) (including BTLE (Bluetooth Low Energy)), Wi-Fi (trademark registered) (Wireless Fidelity), Zigbee (trademark registered), NFC (near field communication), or ANT+(trademark registered), for example. The communication device 18 receives electromagnetic waves in a predetermined frequency band arriving from an external source (for example, the master module 20 or the like) with a wireless antenna, not shown, then extracts a predetermined signal for near field wireless communication from the electromagnetic waves, restores information included in the signal, and outputs the information to the processor 11. The communication device 18 also superimposes information provided from the processor 11 onto the predetermined signal for near field wireless communication and transmits the signal to outside.

The memory 19 is made up of, for example, various IC memories such as ROM (read only memory), flash ROM or RAM (random access memory), or recording media such as hard disk and memory card. In the ROM, for example, programs and data such as the motion measuring program 190 are stored. In the RAM, for example, a memory area (write area for user setting information 191 or the like) usable as a work area for the processor 11 is allocated.

The acceleration sensor 171 detects acceleration in each of three axial directions which intersect with each other (ideally, which are orthogonal to each other) and outputs a digital signal (acceleration data) corresponding to the magnitudes and directions of the detected accelerations on the three axes.

The angular velocity sensor 172 detects angular velocity in each of three axial directions which intersect with each other (ideally, which are orthogonal to each other) and outputs a digital signal (angular velocity data) corresponding to the magnitudes and directions of the measured angular velocities on the three axes.

The GPS sensor 173 is a sensor which generates a signal indicating the position of the sensor module 10 and outputs the signal to the processor 11, and includes a GPS (global positioning system) receiver or the like. The GPS sensor 173 receives electromagnetic waves in a predetermined frequency band transmitted from a positioning satellite, with a GPS antenna, not shown, then extracts a predetermined GPS signal from the electromagnetic waves, and generates a signal indicating a position based on the GPS signal.

The barometric pressure sensor 174 is a sensor which generates a signal indicating the altitude (or the amount of change in altitude) of the sensor module 10 and outputs the signal to the processor 11, and for example, has a pressure sensitive element of a type utilizing changes in the resonance frequency of a vibration member (vibration type). This pressure sensitive element is, for example, a piezoelectric vibrator made of a piezoelectric material such as quartz crystal, lithium niobate, or lithium. tantalate. For example, a tuning fork-type vibrator, double-ended tuning fork-type vibrator, AT vibrator (thickness-shear vibrator), SAW resonator or the like may be used. The altitude resolution of the barometric pressure sensor 174 is, for example, 1 cm or below.

The pulse sensor 175 is a sensor which generates a signal indicating the pulse rate of a human body (or other animal) and outputs the signal to the processor 11, and for example, has a light source such as an LED (light emitting diode) light source which casts measuring light with an appropriate wavelength toward a subcutaneous blood vessel, and a light receiving element which detects changes in the intensity of light generated in the blood vessel according to the measuring light.

The processor 11 of the sensor module 10 samples, for example, at a predetermined frequency, a necessary signal of the signals generated in parallel by various sensors such as the acceleration sensor 171, the angular velocity sensor 172, the GPS sensor 173, the barometric pressure sensor 174 and the pulse sensor 175. The processor 11 also performs necessary processing on the sampled signal and adds time information, thus prepares measured data, and successively transmits the measured data to the master module 20 via the communication device 18. The processor 11 may perform correction processing such as temperature correction on apart or all of the sampled signal, according to need.

### Setting Table

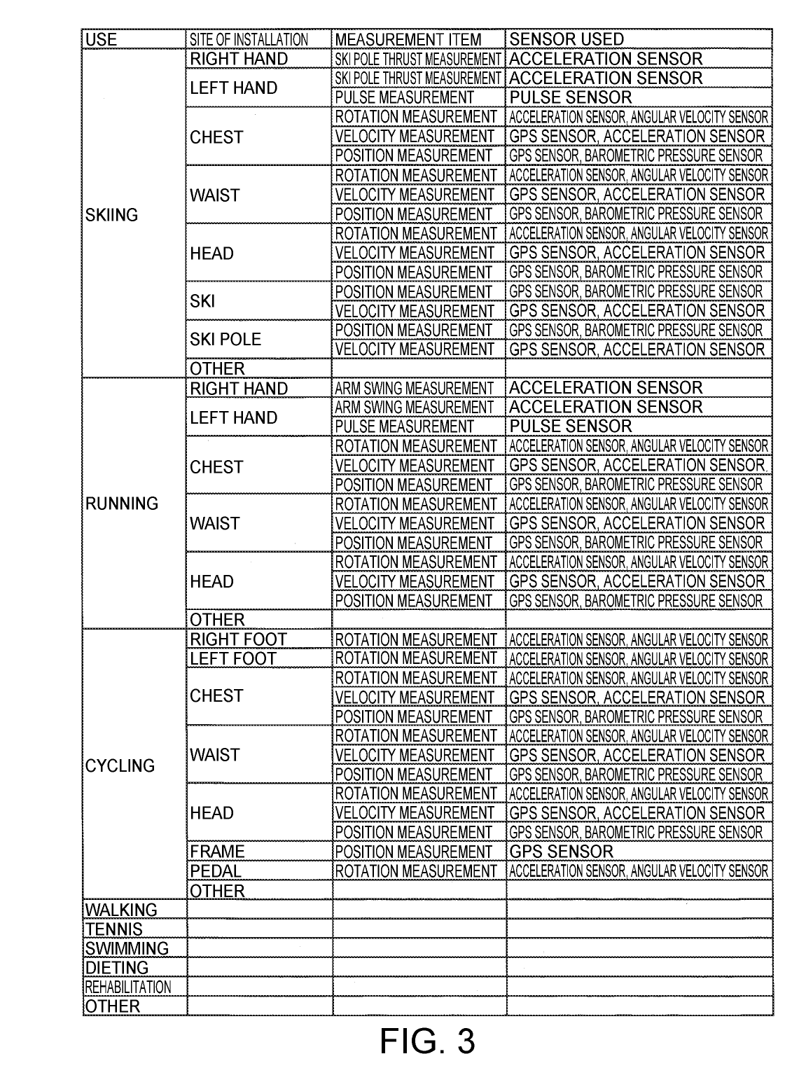

FIG. 3 is an example of a setting table 291 which may be stored in the master module 20. The setting table 291 stores each use of the sensor module, a site of installation of the sensor module corresponding to each use, and an item for measurement of the sensor module corresponding to the site of installation and the use, in association with each other. The term “item for measurement” refers to a measuring content decided by a combination of the type of the signal used for measurement (type of the sensor used) and the type of information generated in measurement (measured data). Hereinafter, it is simply referred to as “measurement item.” The setting table 291 is a table used when the master module 20 displays a select screen, described later.

(1) As for the use, the use of the sensor module is, for example, skiing, running, cycling, walking, tennis, swimming, dieting, rehabilitation or the like, as shown in FIG. 3.

(2) As for the site of installation, the site of installation corresponding to each use of the sensor module is as follows, for example, as shown in FIG. 3.

The site of installation corresponding to the use “skiing” is, for example, “right hand”, “left hand”, “chest”, “waist”, “head”, “ski”, “ski pole”, or the like.

The site of installation corresponding to the use “running” is, for example, “right hand”, “left hand”, “chest”, “waist”, “head”, or the like.

The site of installation corresponding to the use “cycling” is, for example, “right foot”, “left foot”, “chest”, “waist”, “head”, “bicycle frame”, “bicycle pedal”, or the like.

(3) As for the measurement item, the measurement item corresponding to each combination of the use and site of installation of the sensor module is as follows, for example, as shown in FIG. 3.

The measurement item corresponding to the combination of the use “skiing” and the site of installation “right hand” is, for example, “ski pole thrust measurement.” Here, the “ski pole thrust measurement” is, for example, to repeatedly generate measured data indicating whether an acceleration of a predetermined level or above is generated in the sensor module (whether a ski pole thrust is made or not), at predetermined sampling time intervals.

The measurement item corresponding to the combination of the use “skiing” and the site of installation “left hand” is, for example, “ski pole thrust measurement.”

The measurement item corresponding to the combination of the use “skiing” and the site of installation “chest” is, for example, “rotation measurement”, “velocity measurement”, and “position measurement”. Here, the “rotation measurement” is, for example, to repeatedly generate measured data indicating the amount of change in the attitude of the sensor module, at predetermined sampling time intervals. The “velocity measurement” is, for example, to repeatedly generate measured data indicating the velocity of the sensor module, at predetermined sampling time intervals. The “position measurement” is to repeatedly generate data indicating the position of the sensor module, at predetermined sampling time intervals.

The measurement item corresponding to the combination of the use “skiing” and the site of installation “waist” is, for example, “rotation measurement”, “velocity measurement”, and “position measurement”.

(4) As for the sensor, one example of a sensor which maybe used for each item (each measurement item) is as follows.

The sensor used for the measurement item “ski pole thrust measurement” is, for example, the “acceleration sensor”. That is, to generate measured data indicating whether a ski pole thrust is made or not, an output signal from the acceleration sensor is used.

The sensor used for the measurement item “rotation measurement” is, for example, the “angular velocity sensor” and the “acceleration sensor.” That is, to generate measured data indicating the amount of change in attitude, output signals from the angular velocity sensor and the acceleration sensor are used. Although it is possible to omit the use of the acceleration sensor, using the acceleration sensor along with the angular velocity sensor is thought to enable higher accuracy in finding the amount of change in attitude.

The sensor used for the measurement item “velocity measurement” is, for example, the “GPS sensor” and the “acceleration sensor.” That is, to generate measured data indicating the velocity, output signals from the GPS sensor and the acceleration sensor are used. Although it is possible to omit the use of one of the GPS sensor and the acceleration sensor, using both sensors is thought to enable higher accuracy in finding the velocity.

The sensor used for the measurement item “position measurement” is, for example, the “GPS sensor” and the “barometric pressure sensor.” That is, to generate measured data indicating the position, output signals from the GPS sensor and the barometric pressure sensor are used. Although it is possible to omit the use of the barometric pressure sensor, using the barometric pressure sensor along with the GPS sensor is thought to enable higher accuracy in finding the position (altitude in particular).

### Operations of System

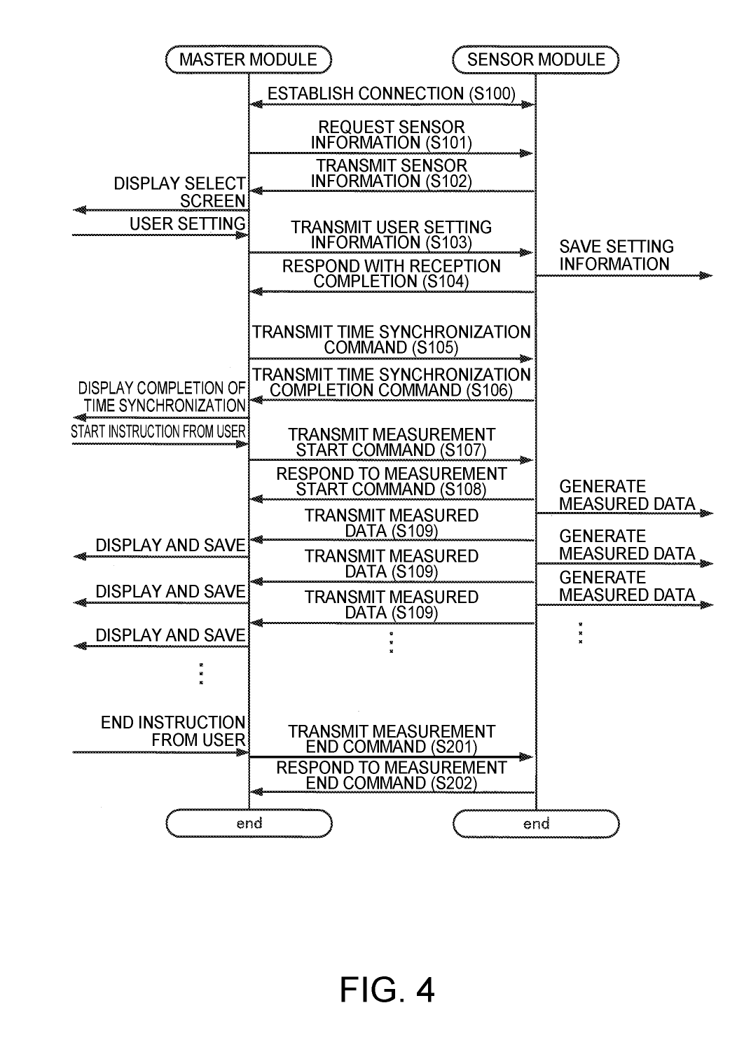

FIG. 4 is a time chart showing the operations of the processor 21 of the master module 20 and the operations of the processor 11 of the sensor module 10 in time series. The processor 21 of the master module 20 operates according to the motion measuring program 290. The processor 11 of the sensor module 10 operates according to the motion measuring program 190. Each step in FIG. 4 is described in order below.

Step S100: The processor 21 of the master module 20 and the processor 11 of the sensor module 10 establish connection with each other via the communication device 28 and the communication device 18. Hereinafter, the operations of the processor 21 and the communication device 28 are described as the operations of the master module 20, and the operations of the processor 11 and the communication device 18 are described as the operations of the sensor module 10.

Step S101: The master module 20 sends a request for sensor information to the sensor module 10. The sensor information is information indicating the measurement item that can be executed by the sensor module 10, for example, hardware information and software information of the sensor module 10. The hardware information of the sensor module 10 indicates the type of the sensor installed in the sensor module 10. The software information of the sensor module 10 indicates the version of the motion measuring program 190 installed in the sensor module 10.

Step S102: In response to the request from the master module 20, the sensor module 10 transmits the sensor information to the master module 20.

Step S103: The master module 20 transmits user setting information inputted by the user, to the sensor module 10. Specifically, the master module 20 displays a select screen (described later) on the display 24 on the basis of the sensor information transmitted from the sensor module 10 and the setting table 291, and allows the user to input necessary information (user setting information) on the select screen, which accepts the user setting information as a user setting input. The user setting information includes information such as the measurement item (including the type information of the sensor used) for the measurement to be executed by the sensor module 10, and measuring parameter set by the user (sampling time interval).

Step S104: The sensor module 10 writes the user setting information into the memory 19. The user setting information 191 will be referred to at the time of generating measured data, described later (that is, at the time of measuring). As the writing of the user setting information 191 (saving of the setting information) is completed, the sensor module 10 sends a response that the reception of the user setting information is completed, to the master module 20.

Step S105: the master module 20 transmits a time synchronization command to the sensor module 10. The time synchronization command includes, for example, information indicating the local time of the master module 20.

Step S106: On receiving the time synchronization command, the sensor module 10 links the local time of the master module 20 to the local time of the sensor module 10, thus takes time synchronization with the master module 20, and then transmits a time synchronization completion command to the master module 20. Here, in the system of this embodiment, since two or more sensor modules 10 are simultaneously used, if each of the two or more sensor modules 10 has taken time synchronization with the master module 20, it means that time synchronization is consequently taken among the two or more sensor modules 10. Also, in the case where each of the two or more sensor modules 10 is synchronous in time with GPS satellites, the two or more sensor modules 10 can be regarded as being synchronous in time with each other. Therefore, in that case, it is possible to omit Step S105 and this Step S106.

Step S107: The master module 20 displays information that the time synchronization of the sensor module 10 has been completed, on the display 24. This enables the user to confirm the completion of the time synchronization. After confirming the completion of the time synchronization of all the sensor modules 10 used simultaneously, the user operates the input 23 at a desired timing so as to input a measurement start instruction to the master module 20 (start instruction from the user). On receiving this input, the master module 20 transmits a measurement start command to the sensor module 10.

Step S108: On receiving the measurement start command, the sensor module 10 starts supplying power to a sensor that is the sensor to be used, of the sensors installed in the sensor module 10 (acceleration sensor 171, angular velocity sensor 172, GPS sensor 173, barometric pressure sensor 174, pulse sensor 175 and the like) (that is, eliminates sensors that are not the sensor to be used, from the target to be supplied with power). The sensor module 10 then sends a response to the measurement start command, to the master module 20.

Step S109: After the response to the command, the sensor module 10 executes measurement according to the user setting information 191. Specifically, the sensor module 10 samples an output signal from a sensor that is the sensor to be used, of the sensors installed in the sensor module 10 (acceleration sensor 171, angular velocity sensor 172, GPS sensor 173, barometric pressure sensor 174, pulse sensor 175 and the like). The sensor module 10 also generates necessary measured data (with sampling time), using the sampled signal. The sensor module 10 then transmits the generated measured data to the master module 20. Meanwhile, the master module 20, on receiving the measured data from the sensor module 10, saves the received measured data in the memory 29 and displays the measured data on the display 24. The master module 20 sets the display form of the measured data on the display 24, for example, to the same display form as the display form designated by the user in advance.

Also, the sensor module 10 repeats the generation and transmission of measured data at sampling time intervals set by the user. Meanwhile, the master module 20 repeats saving and displaying measured data every time measured data is received from the sensor module 10. That is, in the motion measuring system 1 of this embodiment, the display of measured data on the display 24 is successively (in real time) performed during measurement.

Step S201: The user operates the input 23 at a desired timing so as to input a measurement end instruction to the master module 20 (end instruction from the user). The master module 20, having received the end instruction, transmits a measurement end command to the sensor module 10.

Step S202: On receiving the measurement end command, the sensor module 10 stops supplying power to the sensor currently supplied with power, thus ends the measurement, and sends a response to the measurement end command, to the master module 20. With this, the operations of the sensor module 10 and the master module 20 related to measurement end.

### Select Screen

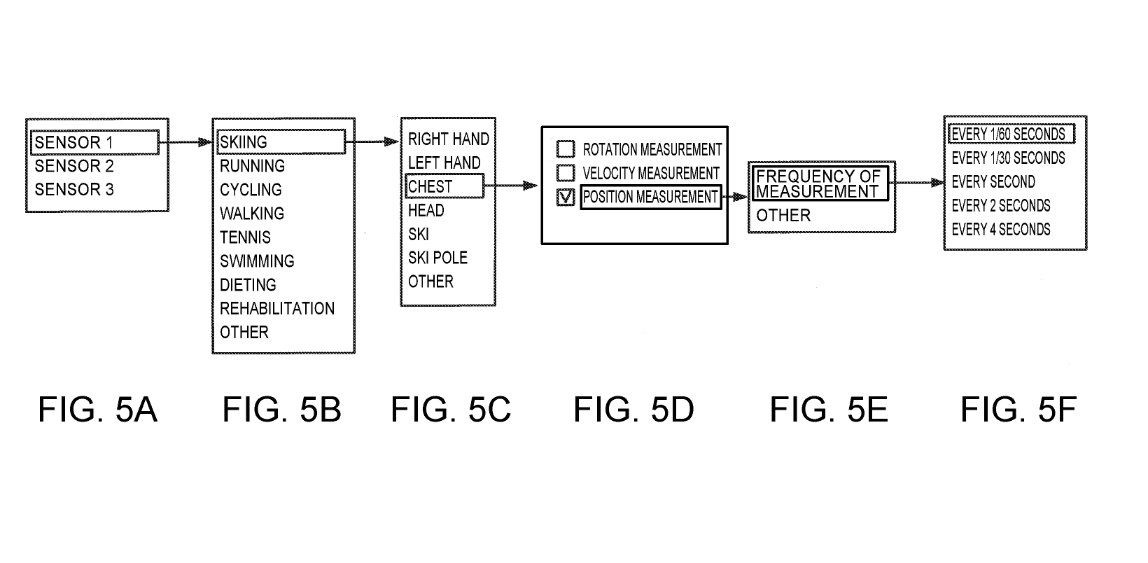

FIG. 5 is an example of a select screen which may be displayed on the display 24 at the time of user setting (Step S103). The user designates a use, site of installation, measurement item, measuring parameter and the like of the sensor module 10, on the select screen.

The select screen in this embodiment includes, for example, a sensor select screen as shown in FIG. 5A, a use select screen as shown in FIG. 5B, a site of installation select screen as shown in FIG. 5C, a measurement item select screen as shown in (FIG. 5D, a parameter type select screen as shown in FIG. 5E, and a parameter select screen as shown in FIG. 5F. Each screen is described below.

In the sensor select screen shown in (FIG. 5A, the name (identification number) or identification icon of one or a plurality of sensor modules with connection established with the master module 20 is listed (though such icons are not shown in FIG. 5A).

The user designates one sensor module on this sensor select screen. In the example of FIG. 5A, it is shown that the “sensor module with the identification number 1” is designated. As the designation of the sensor module is completed, the use select screen is called.

In the use select screen shown in FIG. 5B, options of use, for example, “skiing”, “running”, “cycling”, “walking”, “tennis”, “swimming”, “dieting”, “rehabilitation”, “other” and the like, are listed.

Next, the user designates a use of the sensor module on this use select screen. In the example of FIG. 5B, it is shown that “skiing” is designated. As the designation of the use is completed, the site of installation select screen is called.

In the site of installation select screen shown in FIG. 5C, options of site of installation, for example, “right hand”, “left hand”, “chest”, “waist”, “head”, “ski”, “ski pole”, “other” and the like, are listed, whereas options (for example, “bicycle frame”, “bicycle pedal”) that are inappropriate for the content already designed on the sensor select screen or the use select screen (in this example, “sensor module with the identification number 1”, “skiing”) are eliminated from the listed options.

By thus properly limiting options in the site of installation select screen according to the use of the sensor module, the user can save the time and effort for selection.

Next, the user designates the site of installation of the sensor module on this site of installation select screen. In the example of shown in FIG. 5C, it is shown that “chest” is designated. As the designation of the site of installation is completed, the measurement item select screen is called.

In the measurement item select screen shown in FIG. 5D, options of measurement item, for example, “rotation measurement”, “velocity measurement”, “position measurement” and the like, are listed, whereas options (“ski pole thrust measurement”, “arm swing measurement” and the like) that are inappropriate for the already designated contents (in this example, “sensor module with the identification number 1”, “skiing”, “chest”) are eliminated from the listed options.

As options in the measurement item select screen are thus limited, inappropriate options are eliminated from measurement items to be executed by the sensor module. That is, the master module 20 properly switches measurement items to be executed by the sensor module (measurement content decided on the basis of the type of the sensor used and the type of measured data), according to the use and site of installation of the sensor module.

In the example shown in FIG. 5D, a plurality of measurement items are listed as options. Thus, the user designates a measurement item that is unnecessary to the user, on the measurement item select screen. Alternatively, the user designates a measurement item that is necessary to the user, on the measurement item select screen. In this embodiment, check boxes are used in the measurement item select screen so that the user can choose a plurality of items.

As the user thus inputs his/her request to the master module, unnecessary options are eliminated from measurement items to be executed by the sensor module. That is, the master module 20 limits measurement items to be executed by the sensor module, according to the request from the user.

In the example shown in FIG. 5D, it is shown that “rotation measurement” and “velocity measurement” are unchecked as they are unnecessary measurement items. As the designation of unnecessary measurement items (or the designation of necessary measurement items) is completed, the parameter type select screen is called.

In the parameter type select screen shown in FIG. 5E, options of type of measurement parameter, for example, “frequency of measurement”, “other” and the like, are listed.

The user designates a type of measurement parameter on the parameter type select screen. In the example of FIG. 5E, it is shown that “frequency of measurement (sampling time interval)” is designated. As the designation of the type of measurement parameter is completed, the parameter select screen is called.

In the parameter select screen shown in FIG. 5F, options of measurement parameter, for example, “every 1/60 seconds”, “every 1/30 seconds”, “every second”, “every 2 seconds” and the like, are listed, whereas options that are inappropriate for the already designated contents are eliminated from the parameter select screen.

The user designates a desired measurement parameter value on the parameter select screen.

In the example of FIG. 5F, it is shown that “every 1/60 seconds” is designated. As the designation of the measurement parameter is completed, the user setting is completed.

As the user setting is completed, the master module 20 prepares user setting information including the measurement item (in the example shown in FIG. 5D, “position measurement”), the type of the sensor used, and the measurement parameter (in the example shown in FIG. 5F, “sampling time interval of 1/60 seconds”), designated by the user, and transmits the user setting information to the sensor module designated by the user.

Therefore, the measurement by the sensor module is executed under measurement conditions defined by the user setting information.

### Display Processing

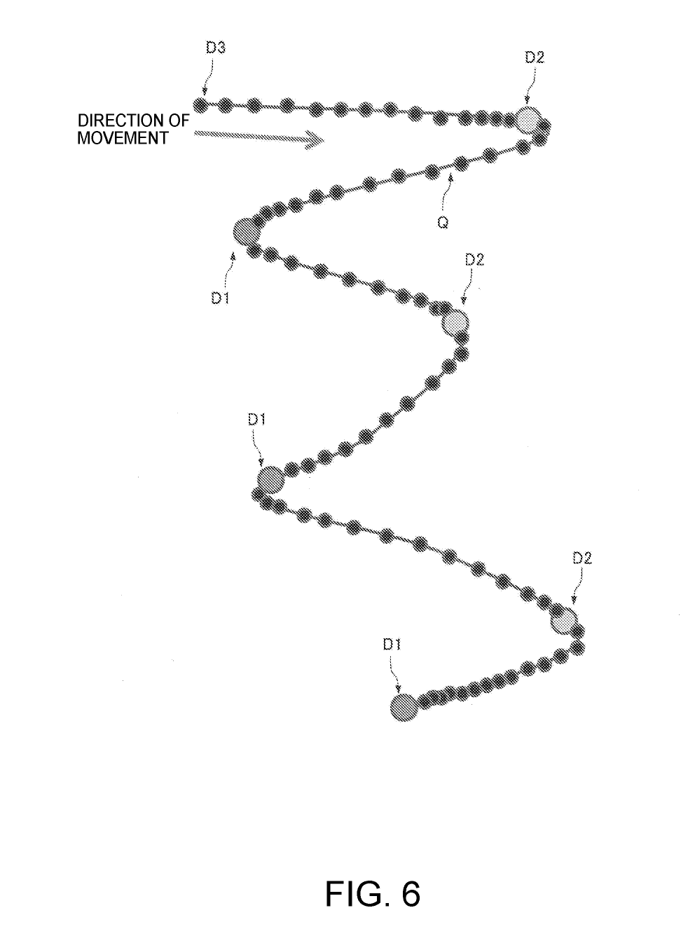

FIG. 6 is an example of a display form of measured data on the display 24. Here, it is assumed that measurement is executed under the following measurement conditions (1) to (8).

(1) The sensor module used: identification numbers 1 to 3.

(2) The use of the sensor modules with the identification numbers 1 to 3: “skiing”.

(3) The site of installation of the sensor module with the identification number 1: “right hand”.

(4) The site of installation of the sensor module with the identification number 2: “left hand”.

(5) The site of installation of the sensor module with the identification number 3: “chest”.

(6) The measurement item for the sensor module with the identification number 1: “ski pole thrust measurement”.

(7) The measurement item for the sensor module with the identification number 2: “ski pole thrust measurement”.

(8) The measurement item for the sensor module with the identification number 3: “position measurement”.

In FIG. 6, the direction of the arrow indicates the direction of movement of the user. Also, in FIG. 6, the marks denoted by a symbol D3 visualize measured data generated by the sensor module with the identification number 3. Each mark D3 represents the position of the user at each sampling point in time.

In FIG. 6, the marks denoted by a symbol D1 visualize measured data generated by the sensor module with the identification number 1. Each mark D1 represents the measured position of the sensor module at the time when the ski pole in the right hand is thrust.

In FIG. 6, the marks denoted by a symbol D2 visualize measured data generated by the sensor module with the identification number 2. Each mark D2 represents the measured position of the sensor module at the time when the ski pole in the left hand is thrust.

In FIG. 6, in order for the user to be able to discriminate the types of measured data from each another, at least one of the color of the mark, the brightness of the mark, the hatching pattern of the mark, and the shape of the mark is different between the marks D1, D2 and D3.

In the example shown in FIG. 6, with the marks D1, D2 and D3, a trajectory Q of the user is shown as well. The trajectory Q of the user is a zigzag line formed by connecting, in time series, the measured positions (marks D3) at the respective sampling points in time, or an approximate curve that approximates the zigzag line.

As described above, the master module 20 in this embodiment gathers measured data generated separately by two or more sensor modules, and displays the gathered measured data in association with each other on the display 24. Such association is enabled by the time synchronization of the two or more sensor modules with each other.

### 1-2. Advantageous Effects of Embodiment

As described above, the master module 20 in this embodiment includes the processor 21 which measures motion, using a signal generated by the sensor module 10 (in the above example, the processor 21 which causes the processor 11 of the sensor module 10 to perform measurement). The processor 21 switches items for measurement according to the site of installation of the sensor module 10.

Specifically, the processor 21 sets an item for measurement that is suitable for the site of installation and use of the sensor module 10 and eliminates an item that is unsuitable for the site of installation and use of the sensor module 10 from items for measurement using, for example the user interface selection screens shown in FIGS. 5A-5F.

Therefore, the user in this embodiment can freely choose a site of installation and use of the sensor module 10. Also, the sensor module 10 will not perform any unwanted operation. Therefore, the sensor module 10 in this embodiment is highly versatile and efficient.

The processor 21 in this embodiment can use signals generated by a plurality of sensors of a plurality of sensor modules 10 and eliminates a sensor that is not used for the measurement of the item in question, of the plurality of sensors, from targets to be supplied with power. Therefore, the processor 21 can restrain the amount of power consumed by the plurality of sensors.

The processor 21 in the embodiment also limits items for measurement according a request from the user.

Specifically, the processor 21 in the embodiment eliminates an item determined as unnecessary by the user, from items for measurement, using for example, the user interface selection screens shown in FIGS. 5A-5F.

Therefore, in the motion measuring system 1 of the embodiment, an increase in the number of items being measured can be prevented. Therefore, an increase in the amount of measured data transferred from the sensor module 10 to the master module 20 can be prevented as well.

Thus, in the system of the embodiment described above, the need to apply so-called high-speed communications between the sensor module 10 and the master module 20 is reduced.

Also, in the motion measuring system 1 of the embodiment, a plurality of sensor modules 10 equipped with a plurality of sensors are provided as separate modules from the master module 20.

Therefore, in the motion measuring system 1 of the embodiment, the size and weight of the sensor module 10 can be restrained by installing several functions that can be installed in the motion measuring system 1 (for example, the input function, the notification function and the like), on the side of the master module 20.

Thus, in the motion measuring system 1 of the embodiment described above, a high degree of freedom can be achieved with respect to the site of installation of the sensor module 10 and a broad range of uses of the sensor module 10 can be secured.

In the motion measuring system 1 of the previously described embodiment, the number of sensor modules 10 is two or more.

Therefore, the user in the embodiment can learn more details of the motion of each part of his/her body by installing the two or more sensor modules 10 separately at different sites on the his/her body or sporting equipment (see FIG. 1).

### 2. Modifications

The claimed invention is not limited to the previous embodiment and can be carried out with various modifications within the intended scope of the claims.

For example, while the master module 20 in the embodiment switches items to be measured according to the use of the sensor module 10 (or limits items according to the use), the master module 20 can be configured not to switch items to be measured according to the use (or not to limit items according to the use).

At least apart of the functions of the master module 20 in the embodiment maybe installed on the side of the sensor module 10 (that is, the sensor module 10 may be used as an example of a motion measuring device).

For example, while the sensor module 10 in the embodiment accepts an input of information by the user via the master module 20, the sensor module 10 may accept an input of information by the user directly from the input 13 (an example of an input device) without using the master module 20. Also, while the sensor module 10 in the embodiment notifies the user of the result of measurement via the master module 20, the sensor module 10 may notify the user of the result of measurement directly from the display 14 (an example of a notification device) without using the master module 20.

Also, a changeover switch may be used as the input 13 of the sensor module 10, and a lamp (colored lamp or the like) may be used as the display 14 of the sensor module 10. In this case, the user may be allowed to switch setting contents by pressing the switch, and the user may be notified of the switching of setting contents via the color of the lamp.

A part of the functions of the sensor module 10 in the embodiment may be installed on the side of the master module 20.

For example, while, in the embodiment, the processor 11 of the sensor module 10 performs the processing related to the generation of measured data, the processor 21 of the master module 20 may perform a part or all of the processing related to the generation of measured data.

Also, in the embodiment, at least a part of the acquired measured data may be uploaded to the internet server. In this case, the user can view or download the measured data at a required timing and on a desired terminal.

The history of measured data acquired in the embodiment may be saved within the system or the network server. In this case, the system (module) may present the history to the user the next time the system is used.

The software in the embodiment may be updatable. For example, it is desirable that the software (motion measuring program 190) of the sensor module 10 is updated at proper timings so that measurement items will be expanded. Also, it is desirable that the software (motion measuring program 290) of the master module 20 is updated at proper timings so that uses, sites of installation, measurement items and the like will be expanded.

In this case, if the user purchases the sensor module 10 (hardware) in advance, the user can add a new sport to use candidates or add a new item to measurement item candidates simply by updating the program. Also, the user can purchase an additional sensor module 10 and use the additional sensor module 10 along with the one or plurality of sensor modules which the user already owns (that is, expand the number of sensor modules).

While, in the embodiment, the master module 20 gathers measured data of the sensor module 10 in real time, the individual sensor modules 10 may hold measured data and one of the sensor modules 10 may gather the measured data in post-processing.

While the notification of the result of measurement to the user is given in the form of a visual display in the system described above, the notification may be given in the form of a notification sound or vibration, instead of or in addition to using a display. By giving the notification in the form of a notification sound or vibration in real time, it is possible to provide real-time coaching.

At least apart of the functions of the master module 20 in the embodiment may be installed in other equipment, for example, wrist equipment, head-mounted display, tablet PC (personal computer), laptop PC, desk-top PC, or network server.

At least a part of the functions of the sensor module 10 in the embodiment may be installed in other mobile equipment, for example, wrist equipment, head-mounted display, or the like.

For example, the pulse sensor of the sensor module 10 may be installed in the head-mounted display. In this case, it is desirable that the pulse sensor is provided in such a way that the head (measurement window) of the pulse sensor contacts the temple of the user. Also, for example, the pulse sensor of the sensor module 10 may be installed in the wrist equipment. In this case, it is desirable that the pulse sensor is provided in such a way that the head of the pulse sensor contacts the wrist of the user.

As the combination of use, site of installation, measurement item and sensor used, of the sensor module 10 in the embodiment, one of the following combinations may be used. In the following list, the highest concept is the “use”, the second highest concept is the “site of installation”, the third highest concept is the “measurement item”, and the lowest concept is the “sensor used”: “running”—“arm”—“arm swing measurement”—“acceleration sensor and angular velocity sensor or the like”; “running”—“arm”—“pulse measurement”—“pulse sensor or the like”; “running”—“waist”—“tilt measurement at the time of landing”—“acceleration sensor or the like”; “running” “waist” “aerial duration” “acceleration sensor or the like”; “running”—“waist”—“center of gravity measurement at the time of landing”—“acceleration sensor or the like”; “skiing”—“boot”—“load measurement”—“acceleration sensor or the like”; “skiing”—“ski pole”—“ski pole thrust measurement”—“acceleration sensor or the like”; “skiing”—“waist”—“tilt measurement”—“acceleration sensor or the like”; “skiing”—“waist”—“vertical motion measurement”—“acceleration sensor or the like”; “skiing”—“chest”—“vertical motion measurement”—“acceleration sensor or the like”; “skiing”—“chest”—“pulse measurement”—“pulse sensor or the like”; “cycling”—“frame”—“tilt measurement”—“acceleration sensor or the like”; and “cycling”—“pedal”—“rotation measurement”—“angular velocity sensor or the like”.

In the embodiment, as the use of the sensor module 10, mountaineering, skating, golf, baseball, football, motorcycling, motor sports, boating (rowboat, motor boat), yachting, trail running, paragliding, dancing, combat sports, sleeping, sport kite flying, dog sledding or the like may be employed as well as skiing (including cross-country skiing and ski jump), running, cycling, walking, tennis, swimming, dieting, and rehabilitation.

In the embodiment, as the site of installation of the sensor module 10, a person, sporting equipment such as a bicycle, car or racket, and other moving bodies, for example, an animal and walking robot, may be employed.

While the GPS (Global Positioning System) is used as a global satellite positioning system in the embodiment, other types of GNSS (Global Navigation Satellite System) may also be used. For example, one, or two or more of the EGNOS (European Geostationary-Satellite Navigation Overlay Service), QZSS (Quasi Zenith Satellite System), GLONASS (GLObal NAvigation Satellite System), GALILEO, BeiDou (BeiDou Navigation Satellite System), and the like, may be used. Also, as at least one of the satellite positioning systems, an SBAS (Satellite-based Augmentation System) such as the WAAS (Wide Area Augmentation System) or EGNOS (European Geostationary-Satellite Navigation Overlay Service) may be used.

The embodiment and modifications are simply examples and are not limiting. For example, it is possible to combine some of the embodiment and modifications according to need.

The disclosure includes configurations that are substantially the same as the configurations described in the embodiment (for example, a configuration with the same functions, method and results, or a configuration with the same objectives and effects). The disclosure also includes configurations in which nonessential parts of the configurations described in the embodiment are replaced with different components. The disclosure also includes configurations that can achieve the same advantageous effects as the configurations described in the embodiment, or configurations that can achieve the same objectives. Moreover, the disclosure includes configurations in which a known technique is added to the configurations described in the embodiment.

What is claimed is:

1. A motion measuring device comprising a processor which executes:
measuring a motion with the use of a signal generated by a sensor; and
switching an item for the measurement of motion to another item for measurement of motion according to a site of installation of the sensor.

2. The motion measuring device according to claim 1, wherein the processor is able to use a signal generated by a plurality of sensors, and eliminates a sensor of the plurality of sensors that is not used for the measurement of the item from being supplied with power.

3. The motion measuring device according to claim 1, wherein the processor switches the item for the measurement of motion to another item according to a use of the sensor.

4. The motion measuring device according to claim 1, wherein the processor further limits the item for the measurement of motion in response to a request by a user.

5. The motion measuring device according to claim 1, further comprising an input device which accepts an input of information about the site of installation.

6. The motion measuring device according to claim 3, further comprising an input device which accepts an input of information about the use of the sensor.

7. The motion measuring device according to claim 4, further comprising an input device which accepts an input of the request by a user.

8. The motion measuring device according to claim 1, further comprising a notification device which notifies a user of a result of the measurement of motion.

9. The motion measuring device according to claim 1, further comprising the sensor.

10. The motion measuring device according to claim 1, further comprising a communication device which receives the signal from the sensor.

11. A motion measuring system comprising:
a motion measuring device including a processor which executes measuring a motion with the use of a signal generated by a sensor, and switching an item for the measurement to another item according to a site of installation of the sensor; and
a sensor device including the sensor.

12. A motion measuring method comprising:
causing a processor to measure a motion with the use of a signal generated by a sensor; and
causing the processor to switch an item for the measurement to another item according to a site of installation of the sensor.

13. A motion measuring program causing a computer to execute:
measuring a motion with the use of a signal generated by a sensor; and
switching an item for the measurement to another item according to a site of installation of the sensor.

14. A sensor module comprising:
at least one sensor which generates a signal corresponding to a motion; and
a communication device which outputs information based on the signal from the at least one sensor corresponding to a site of installation of the sensor module.

15. A sensor module comprising:
at least one sensor which generates a signal corresponding to a motion; and
a display or audio which outputs information based on the signal from the at least one sensor corresponding to a site of installation of the sensor module.

16. A motion measuring device comprising at least one sensor which generates a signal corresponding to a motion,
wherein items for measurement are switched according to a site of installation of the sensor.
